(19) United States
(12) Patent Application Publication
(10) Pub. No.: US 2015/0098512 A1
(43) Pub. Date: Apr. 9, 2015

(54) IMAGE PROCESSING APPARATUS AND METHOD THEREOF

(71) Applicant: CANON KABUSHIKI KAISHA, Tokyo (JP)

(72) Inventor: Eishi Takeda, Tokyo (JP)

(21) Appl. No.: 14/508,311

(22) Filed: Oct. 7, 2014

(30) Foreign Application Priority Data
Oct. 9, 2013 (JP) 2013-212356

(51) Int. Cl. H04N 19/176

(52) U.S. Cl. CPC H04N 19/00278
USPC 375/240.24

(57) ABSTRACT

An image processing apparatus converts a frame size of a decoded moving image, determines a block size for re-encoding the decoded moving image with the frame size being converted, and encodes the decoded moving image with the frame size being converted in accordance with the determined block size.

### BACKGROUND

1. Field of the Invention

The present invention relates to an image processing apparatus, an encoding apparatus, and a method thereof.

2. Description of the Related Art

Conventionally, as a camera integrated moving image recording apparatus which captures an image of an object and records moving image data obtained upon compression encoding of the data, a digital video camera is known well.

As a compression scheme, there is generally used the MPEG2 scheme or H.264 scheme which can perform compression at a high compression ratio by using inter-frame motion prediction. In addition, recently, the HEVC standard (ISO/IEC23008-2) has been used, which can perform highly efficient compression by using a more complex prediction scheme.

According to this HEVC scheme, it is possible to code an input video upon dividing it into image blocks called CTUs (Coding Tree Units). A CTU can be selected from 64×64, 32×32, and 16×16. With regard to these CTUs, prediction, transformation, quantization, and entropy encoding are performed in units of encoding process called CUs (Coding units) upon hierarchically dividing each CTU. For this reason, image quality is greatly influenced by the performance of a encoder, that is, determining and assigning proper CU sizes in accordance with the pictorial pattern of an input image as an encoding target.

On the other hand, there is known a technique of performing the transcoding process of decoding a moving image content having undergone the above compression encoding and then encoding the content again so as to redistribute the content in accordance with the specifications and bands of different playback apparatuses and networks. In general, transcoding process is performed to decode all compression-encoded stream data into image data at all the pixel levels and then encode the data all over again, and hence can partially simplify the re-encoding process by reusing parameters used at the time of decoding (see International Publication No. 2010/079797 pamphlet). International Publication No. 2010/079797 pamphlet discloses a technique of reusing a motion vector, block type, and prediction mode at the time of re-encoding upon modifying them in accordance with a frame size.

If re-encoding moving image data encoded by the above HEVC scheme, however, the method disclosed in International Publication No. 2010/079797 pamphlet cannot determine CU sizes, and hence it is necessary to reanalyze the image data after decoding. This may lead to increases in circuit size and power consumption, and eventually to an increase in processing time.

### SUMMARY

According to an aspect of the present invention, there is provided at least one of a novel image processing apparatus and a novel encoding apparatus.

According to another aspect of the present invention, there is provided an improved technique or new technique of accurately determining CU sizes at the time of coding without analyzing an input image again at the time of re-encoding using the HEVC scheme.

According to another aspect of the present invention, there is provided an image processing apparatus comprising: a conversion unit configured to convert a frame size of a decoded moving image; a determination unit configured to determine a block size for re-encoding the decoded moving image with the frame size being converted; and an encoding unit configured to encode the decoded moving image with the frame size being converted in accordance with the determined block size.

According to another aspect of the present invention, there is provided an encoding apparatus comprising: a conversion unit configured to convert a frame size of a decoded moving image; a determination unit configured to determine a block size for re-encoding the decoded moving image with the frame size being converted; and an encoding unit configured to encode the decoded moving image with the frame size being converted in accordance with the determined block size.

Further features and aspects of the present invention will become apparent from the following description of exemplary embodiments.

### BRIEF DESCRIPTION OF THE DRAWINGS

FIG. 1 is a block diagram for illustrating components of an image processing apparatus (or encoding apparatus) according to a first and second exemplary embodiments;

FIG. 2 is a block diagram for illustrating components of an encoding unit according to the first exemplary embodiment;

FIG. 3 is a flowchart for illustrating a process according to the first exemplary embodiment;

FIGS. 4A and 4B are views for illustrating CU size distribution information according to the first exemplary embodiment;

FIGS. 5A to 5E are views for illustrating a CU size determination process according to the first exemplary embodiment;

FIG. 6 is a block diagram for illustrating components of an encoding unit according to a second exemplary embodiment;

FIG. 7 is a flowchart for illustrating a process according to the second exemplary embodiment; and

FIGS. 8A to 8C are views for illustrating a CU size determination process according to the second exemplary embodiment.

### DESCRIPTION OF THE EMBODIMENTS

Exemplary embodiments, features, and aspects of the present invention will be described below with reference to the drawings.

### First Exemplary Embodiment

### <Overall System Configuration>

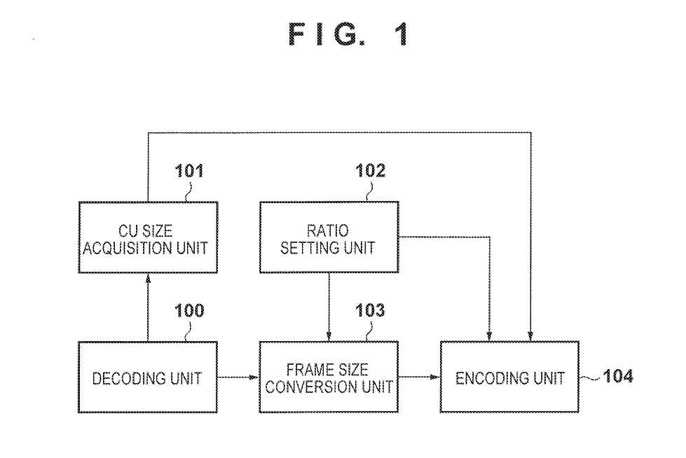

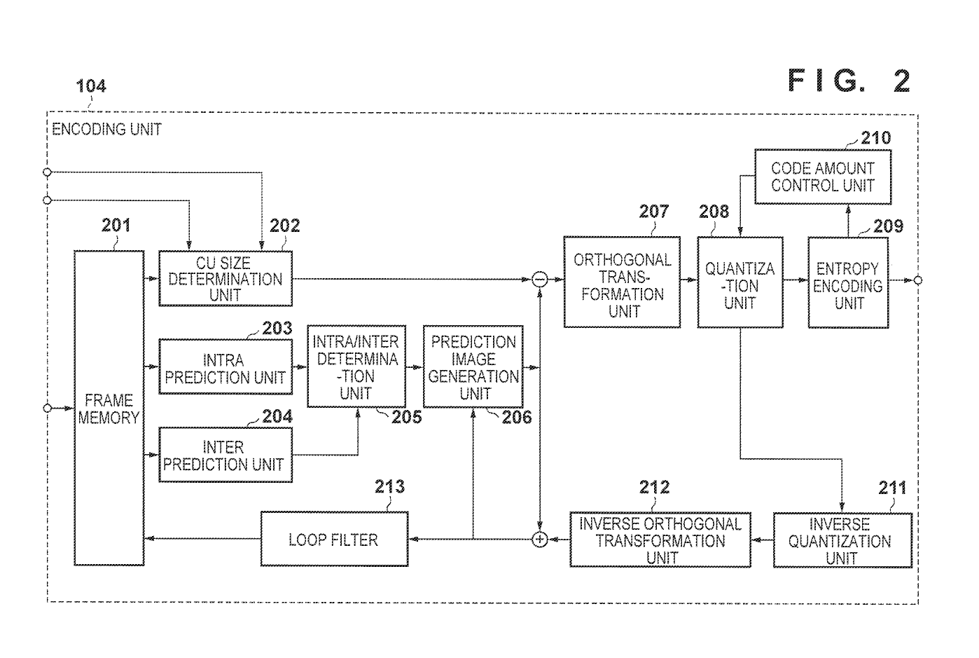

The first exemplary embodiment will be described below with reference to the accompanying drawings. FIG. 1 is a block diagram for illustrating components of an image processing apparatus (or encoding apparatus) to which the first and second exemplary embodiments are applied. FIG. 2 is a block diagram for illustrating components of an encoding unit according to the first exemplary embodiment. This image processing apparatus can be an arbitrary information processing terminal such as a personal computer, digital camera, cell phone, smartphone, PDA, tablet terminal, or TV set.

This image processing apparatus includes a decoding unit 100, a CU size acquisition unit 101, a ratio setting unit 102, a frame size conversion unit 103, and an encoding unit 104. At least of the decoding unit 100, the CU size acquisition unit 101, the ratio setting unit 102, the frame size conversion unit 103, and the encoding unit 104 may have a hardware structure. These units may be implemented in the form of hardware by using dedicated logic circuits and memories or may be implemented in the form of software by making a computer such as a CPU execute processing programs stored in a memory. The image processing apparatus is configured to sequentially perform a decoding process and an encoding process on a picture basis. However, the apparatus may be configured to implement parallelization using a pipeline arrangement, and is not specifically limited in the present invention.

The decoding unit 100 outputs, to the frame size conversion unit 103, the decoded moving image obtained by decoding a bit stream encoded in accordance with the HEVC standard. In addition, the decoding unit 100 stores/holds CU size information on a CTU basis acquired from a stream in a decoding process and used as decoding parameters, and notifies the CU size acquisition unit 101 of the information. The CU size acquisition unit 101 acquires the CU sizes with which a CTU is divided and quantized in the image data decoded by the decoding unit 100, and notifies a CU size determination unit 202 of the encoding unit 104 (to be described later) of the CU sizes.

The ratio setting unit 102 determines the ratio of frame sizes subjected to conversion from the frame size of a decoded moving image and the frame size subjected to re-encoding under the control of a microcomputer such as a CPU, and notifies the frame size conversion unit 103 and the CU size determination unit 202 of the encoding unit 104 of the determined ratio. The frame size conversion unit 103 converts the decoded moving image input from the decoding unit 100 into a different frame size by performing thinning out and an interpolation process for pixel data based on the settings in the ratio setting unit 102, and outputs the different frame size to the encoding unit 104. The encoding unit 104 encodes and compresses the video input from the frame size conversion unit 103 according to the HEVC standard based on the set values in the CU size acquisition unit 101 and the ratio setting unit 102, and outputs the resultant bit stream.

The encoding unit 104 of the first exemplary embodiment will be subsequently described with reference to the block diagram of FIG. 2. The encoding unit 104 is constituted by a frame memory 201, the CU size determination unit 202, an intra prediction unit 203, an inter prediction unit 204, an intra/inter determination unit 205, a prediction image generation unit 206, an orthogonal transformation unit 207, a quantization unit 208, an entropy encoding unit 209, a code amount control unit 210, an inverse quantization unit 211, an inverse orthogonal transformation unit 212, and a loop filter 213. At least one of the frame memory 201, the CU size determination unit 202, the intra prediction unit 203, the inter prediction unit 204, the intra/inter determination unit 205, the prediction image generation unit 206, the orthogonal transformation unit 207, the quantization unit 208, an entropy encoding unit 209, the code amount control unit 210, the inverse quantization unit 211, the inverse orthogonal transformation unit 212, and the loop filter 213 may have a hardware structure.

The frame memory 201 stores each frame data of a decoded moving image after frame size change, which is output from the frame size conversion unit 103, and reference image data used for a motion prediction process to be described later. The CU size determination unit 202 receives notifications concerning the CU size distribution of a decoded moving image and a frame size conversion ratio from the CU size acquisition unit 101 and the ratio setting unit 102. The CU size determination unit 202 then determines the assignment of CU sizes as coding units of the image block on CTU basis with respect to an encoding target image in accordance with the information.

The intra prediction unit 203 reads out the image data of an encoding target block from the frame image data stored in the frame memory 201, and calculates the correlation between a plurality of intra prediction images generated from pixel data around the encoding target block. The intra prediction unit 203 then selects an intra prediction scheme exhibiting the highest correlation and notifies the intra/inter determination unit 205 of the scheme.

The inter prediction unit 204 calculates a motion vector by performing pattern matching between the pixel data of the original image as an encoding target stored in the frame memory 201 and encoded image data on a block basis in the same manner as described above. The intra/inter determination unit 205 selects and determines a prediction scheme for encoding based on the results output from the intra prediction unit 203 described above and the inter prediction unit 204.

As a specific selection method, the intra/inter determination unit 205 derives and compares the prediction errors between the encoding target image and the prediction image calculated from the encoding target image block by the intra prediction unit 203 and the prediction image generated from a reference image by using the motion vector obtained by the inter prediction unit 204. Alternatively, it is possible to use a method of obtaining prediction errors in advance by using the intra prediction unit 203 and the inter prediction unit 204, and making the intra/inter determination unit acquire the prediction errors as evaluation values and compare them with each other. The intra/inter determination unit 205 then determines a prediction mode exhibiting a smaller difference value as an encoding prediction mode as a result of comparison between the prediction errors, and outputs the determined mode to the prediction image generation unit 206.

The prediction image generation unit 206 generates a prediction image in accordance with the prediction mode selected by the intra/inter determination unit 205. The generated prediction image is output to the subtractor on the previous stage of the orthogonal transformation unit 207 to calculate a difference image with respect to the input image or is output to the adder on the subsequent stage of the inverse orthogonal transformation unit 212 to generate a locally decoded image. The orthogonal transformation unit 207 transforms pixel data into a spatial frequency region by performing spatial resolution transformation of the pixel data on a block basis. The quantization unit 208 calculates a quantization coefficient based on a target code amount, and performs a quantization process for the coefficient data transformed into the spatial frequency region by the orthogonal transformation unit 207. The quantized coefficient data is output to both the entropy encoding unit 209 to perform entropy encoding and the inverse quantization unit 211 to calculate a reference image and prediction image.

The entropy encoding unit 209 compresses information by entropy encoding using the unevenness of the occurrence probabilities of bit data of the CABAC (Context Adaptive Variable Length Coding) scheme or the like using a quantized coefficient or a vector value used for motion prediction in the case of inter prediction. The encoded data after compression is output as a bit stream and recorded on a recording medium such as a memory card or hard disk. The code amount control unit 210 acquires the code amount of the encoded data output from the entropy encoding unit 209. The code amount control unit 210 calculates a target code amount per picture based on a bit rate or buffer model, and performs feedback control set in the quantization unit 208.

The inverse quantization unit 211 calculates coefficient data by multiplying the coefficient data quantized by the quantization unit 208 by a re-quantization coefficient. The inverse orthogonal transformation unit 212 performs inverse orthogonal transformation of the coefficient data output from the inverse quantization unit 211 into coefficient data. The loop filter 213 performs a filter process for the image data obtained by adding the image data output from the inverse orthogonal transformation unit 212 to a prediction image so as to reduce encoding deformation which occurs at a block boundary, and stores the resultant data in the frame memory 201. The exemplary components of the encoding unit 104 according to the first exemplary embodiment.

<Operation Procedure>

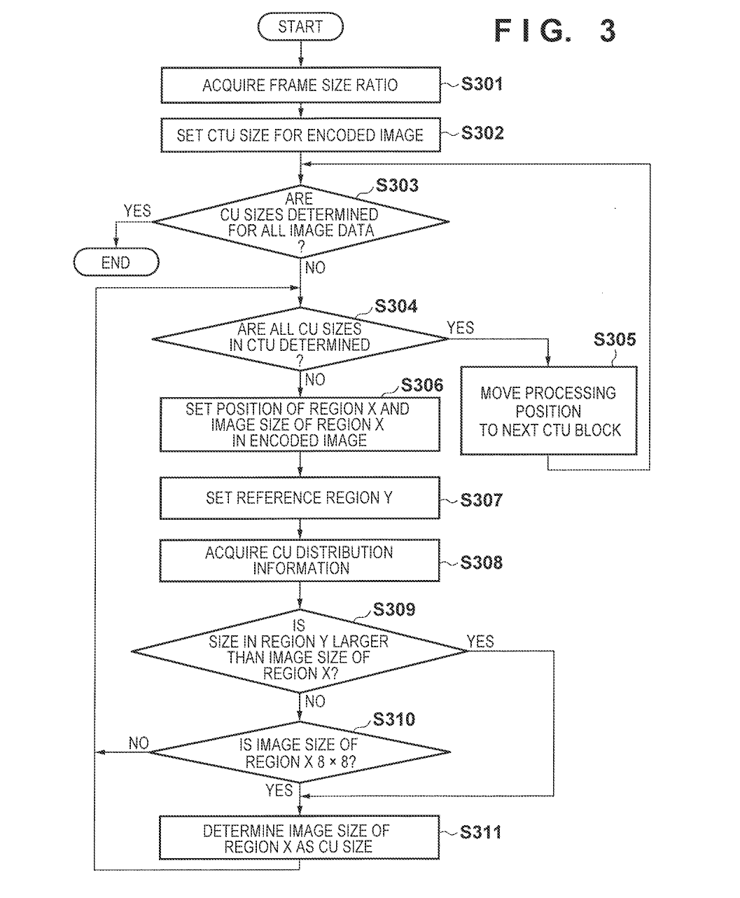

A process using the above system configuration performed in the image processing apparatus according to the first exemplary embodiment will be described with reference to FIG. 3. The CU size acquisition unit 101, the ratio setting unit 102, and the CU size determination unit 202 execute this process. Assume that this procedure is executed on a picture basis. The process corresponding to this flowchart can be implemented by causing a CPU functioning as these units to execute corresponding a program (stored in a ROM or the like).

First of all, in step S301, the CU size determination unit 202 acquires, from the ratio setting unit 102, a frame size ratio R between a decoded moving image and an input moving image as an encoding target after frame size conversion. Assume that the information of the frame size ratio R is given as R=½ because the ratio between the number of pixels in the horizontal direction and the number of pixels in the vertical direction is ½ if, for example, encoding 1920 pixels×1080 lines upon reducing a decoded moving image with a frame size of 3840 pixels×2160 lines. In another case, R=⅔ may be set if, for example, encoding 1280 pixels×720 lines upon reducing a decoded moving image with a frame size of 1920 pixels×1080 lines.

Subsequently, in step S302, the CU size determination unit 202 determines the pixel size of a CTU corresponding to the maximum value of image block sizes if quantizing an encoded moving image. At the start of encoding, a CTU size can be selected from 64×64, 32×32, and 16×16. In the first exemplary embodiment, 64×64 is set as a CTU size, but the CTU size is not specifically limited if executing the present invention. Assume that the encoding unit 104 will perform a series of processes including inter prediction, intra prediction, quantization, orthogonal transformation, and entropy encoding for each CU obtained by hierarchically dividing this CTU. In addition, assume that a CU size assignment process is recursively executed until CU sizes are determined for all image block data contained in the CTU, and then sequentially performed from the upper left to the right of an encoded moving image on a CTU basis.

In step S303, it is determined whether the CU size determination unit 202 has assigned CU sizes at the time of encoding to all the image block data in the encoding target picture. This process is repeatedly performed throughout one picture. If the assignment of CU sizes to all the CTUS in the picture is complete (YES in step S303), the procedure is terminated, and subsequent encoding process is performed. If there is any CTU block to which no CU size has been assigned (NO in step S303), it is determined in step S304 whether the CU size determination unit 202 has assigned CU sizes to all the image block data in the CTU block. This process is repeatedly performed until it is determined in this condition determination step that CU sizes have been assigned to all the image block data in the CTU block.

If it is determined that CU sizes have been assigned to all the data in the CTU block (YES in step S304), the CU size determination unit 202 moves the process position to the start pixel position of the next CTU block in step S305. If there is any image block to which no CU size has been assigned (NO in step S304), a CU size candidate region X is set, in step S306, in the image block region which exists in the CTU block and to which no CU size has been assigned. The assignment of image sizes to the CU size candidate region X starts with a pixel size of 64×64 pixels as an initial value in a loop process on a CTU basis which starts from step S304. Thereafter, image sizes are so set as to decrease stepwise from 32×32 to 16×16 and 8×8 in accordance with processing results on the subsequent stage.

In step S307, the CU size determination unit 202 sets the image block region obtained by multiplying the CU size candidate region X by the reciprocal of the frame size ratio R acquired in step S301 as a reference region Y for the acquisition of a CU distribution in a decoded moving image. If, for example, the image size of the region X corresponding to a CTU block is 64×64 pixels and R=½, the initial value of the image size of the reference region Y is set to 128×128 pixels. If the region X is divided and re-set afterward, a new reference region Y is set in the initial reference region Y with 128×128 pixels according to the division method. In addition, the reference region Y exists in the decoded moving image at a position corresponding to a relative position in the moving image as a re-encoding target in the region X.

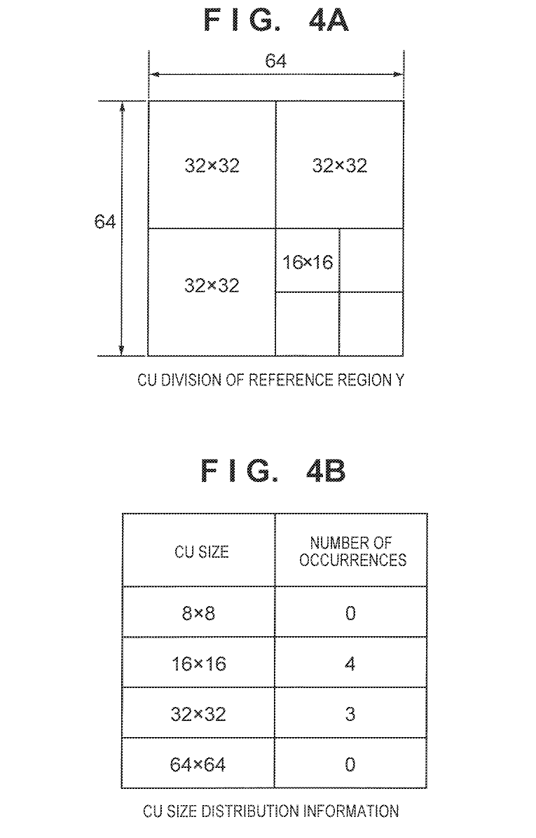

Subsequently, in step S308, the CU size determination unit 202 acquires, from the CU size acquisition unit 101, the size information (the block size information) of CUs included in the image block reference region Y set in step S307 in the decoded moving image. For example, as shown in FIG. 4B, there is available an effective method of managing CU size information in accordance with the numbers of the respective CU sizes appearing in the Y region of a decoded moving image in a table form. The case shown in FIG. 4B is a table structure if, of the 64×64 pixels in the Y region, a CU size of 32×32 pixels is assigned to three blocks, and a CU size of 16×16 pixels is assigned to four blocks.

In step S309, the CU size determination unit 202 determines based on CU size distribution information in the reference region Y whether all the CU sizes in the Y region are larger than the image size of the CU size candidate region X. If the CU size determination unit 202 determines in step S309 that all the CU sizes in the region Y are larger than the image size of the region X (YES in step S309), the CU size determination unit 202 determines the image size of the region X as a CU size in step S311. On the other hand, if the distribution of the CU sizes in the region Y includes a CU size equal to or less than the image size of the region X (NO in step S309), the CU size determination unit 202 determines in step S310 whether the image size of the region X is 8×8. If the CU size determination unit 202 determines in step S310 that the image size of the region X is 8×8 (YES in step S310), the CU size determination unit 202 determines the image size of the region X as a CU size in step S311. If the image size of the region X is not 8×8 (NO in step S310), the process returns to step S304 again to set a value smaller by one step in the range of values which can be selected in terms of specifications and repeat the process until YES is obtained in step S309 or S310.

In the case of a CU size distribution in the reference region Y shown in FIG. 4A, if the image size of the candidate region X is 32×32 pixels, the reference region Y includes a CU with an image size of 16×16 pixels. Therefore, it is determined that the CU size in the region X at the time of re-encoding should be set to a value smaller than 32×32, and the region X is divided into four blocks. In addition, even if all the blocks in the region Y are formed from CUs with a size of 32×32 pixels, the region X is divided into blocks with a pixel size of 16×16 pixels so as to encode the region X upon setting the CU size in the region X to a value smaller than 32×32. If the region Y includes a CU with a size of 16×16 pixels, the region X is divided into four blocks each having a size of 8×8 pixels so as to encode the region X upon setting the CU size in the region X to a value smaller than 16×16 pixels. If the region X is divided into blocks each having a size of 8×8 pixels, since the region cannot be divided into smaller blocks, the pixel size in the region X is 8×8 pixels. The procedure for a CU size assignment process at the time of re-encoding has been described above.

### Application Example

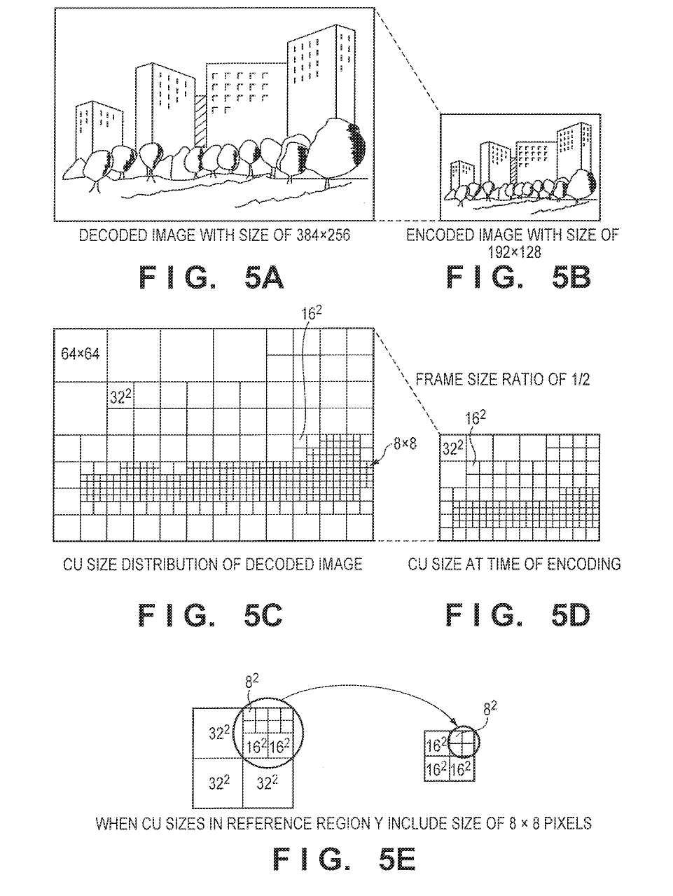

An application example of determining CU sizes at the time of re-encoding by using the operation procedure described above will be described with reference to FIG. 5. In the case shown in FIG. 5, for the sake of simplicity, a decoded moving image (FIG. 5A) with a frame size of 384 pixels×256 lines obtained by an image capturing buildings and trees is re-encoded upon being reduced by half to a frame size of 192 pixels×128 lines (FIG. 5B). In this case, if the result shown in FIG. 5C is obtained as the CU size distribution acquired in the process of decoding to output a decoded moving image, the sizes shown in FIG. 5D are determined as CU sizes at the time of re-encoding according to the above operation procedure, and the image is encoded.

For example, an image region corresponding to the sky on the upper left end of the frame of the decoded moving image is quantized with a large CU size of 64×64 pixels because the region is flat and exhibits high redundancy as image data. A CU size of 32×32 pixels is selected for re-encoding of this image region. Likewise, for a CU size of 32×32 pixels in the decoded moving image, a CU size of 16×16 pixels is used at the time of re-encoding.

In addition, if the pixel regions of the decoded moving image include at least one region with a CU size of 8×8 pixels, block division is performed such that all the corresponding 16×16 pixel regions in the re-encoded moving image are formed from four blocks each having the minimum CU size of 8×8 pixels, as shown in FIG. 5E. Referring to FIG. 5E, the 64×64 pixel region as the region Y is constituted by three 32×32 pixel blocks, two 16×16 pixel blocks, and eight 8×8 pixel blocks. In this case, in the region X, the CU size of the 32×32 pixel blocks is determined to be a CU size of 16×16 pixels, and the CU size of the remaining one 16×16 pixel region is determined to be a CU size of 8×8 pixels based on the presence of the 8×8 pixel blocks.

As described above, in the first exemplary embodiment, CU sizes at the time of re-encoding are determined based on frame size ratio and CU size distribution of a decoded moving image. This makes it unnecessary to reanalyze the pictorial pattern or structure of an encoding target image at the pixel level. In addition, this allows high speed calculation using a simple algorithm, and hence can suppress an increase in processing time if performing re-encoding. Note that according to the description of the first exemplary embodiment, the frame size ratios in the horizontal and vertical directions are both ½. However, even if other frame size ratios are to be handled or conversion ratios in the horizontal and vertical directions differ from each other, CU sizes in the region X may be determined with priority being given to a smaller CU size in accordance with the CU distribution of a decoded moving image included in the reference region Y set in accordance with the ratios in the horizontal and vertical directions.

### Second Exemplary Embodiment

The first exemplary embodiment has exemplified the method of determining CU sizes in a re-encoded moving image based on the CU size distribution of a decoded moving image and the ratio between the frame size of the decoded moving image and that of an image at the time of re-encoding. In contrast to this, in the second exemplary embodiment, if a pixel size of 8×8 pixels is selected as a CU size in a decoded moving image, an orthogonal transformation size is set to a block size smaller than a size of 8×8 pixels in a corresponding image region to be re-encoded. This operation is executed as a further different operation. This makes it possible to reflect, in an operation at the time of re-encoding, the distribution of image data having a fine structure, that is, many high frequency components, in a decoded moving image. It is therefore possible to maintain high image quality.

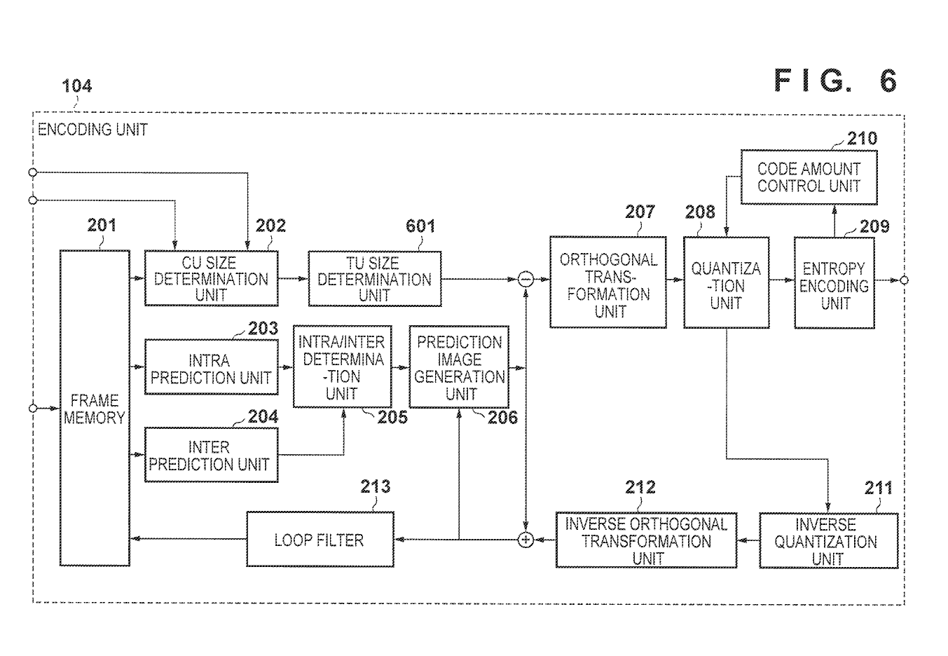

In this case, pixel sizes subjected to orthogonal transformation are those based on a scheme capable of hierarchically dividing each image block called a TU (Transform Unit) defined by the HEVC standard, like a CU described above, by performing orthogonal transformation for each image block. There are four types of pixel sizes which can be selected as TU sizes, namely 32×32, 16×16, 8×8, and 4×4. The second exemplary embodiment will be described below with reference to FIGS. 6, 7, and 8. Note that in the description of the second exemplary embodiment, a description of portions common to the first exemplary embodiment will be omitted as needed.

<Overall System Configuration>

An encoding unit which implements the second exemplary embodiment shown in FIG. 6 includes a TU size determination unit 601. The TU size determination unit 601 may have a hardware structure. Based on the CU sizes determined by a CU size determination unit 202, the TU size determination unit 601 determines block sizes for the execution of orthogonal transformation with respect to an image contained in the CU block. An orthogonal transformation unit 207 performs orthogonal transformation for a target image block based on the TU sizes determined by the TU size determination unit 601. Functions of the other units are the same as those in the first exemplary embodiment, and hence a description of them will be omitted.

<Operation Procedure>

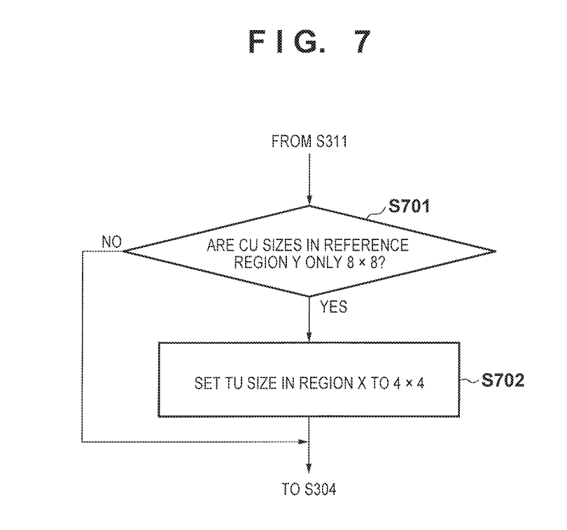

A CU sizes and TU size determination process performed in the image processing apparatus according to the second exemplary embodiment will be described below with reference to FIG. 7. This operation procedure is executed following the process from step S301 to step S311 in the first exemplary embodiment. In step S701, it is determined whether the CU size distribution of a reference region Y in the decoded moving image acquired in step S308 is constituted by only pixel blocks each having a minimum size of 8×8 pixels. If all the CU sizes in the reference region Y of the decoded moving image are 8×8 pixels (YES in step S701), the TU size is set to 4×4 so as to perform orthogonal transformation upon dividing a CU pixel block in a region X at the time of encoding into four 4×4 pixel blocks. On the other hand, if the reference region Y includes a CU having a CU size larger than 8×8 pixels (NO in step S701), the process returns to step S304 to continue the process without performing TU size determination. In this case, with regard to a CU to which no TU size has been set, a TU size is determined based on a prediction residue in intra/inter prediction, a prediction mode, or the like as in the related art.

The procedure for CT size and TU size assignment at the time of re-encoding in the second exemplary embodiment has been described above.

### Application Example

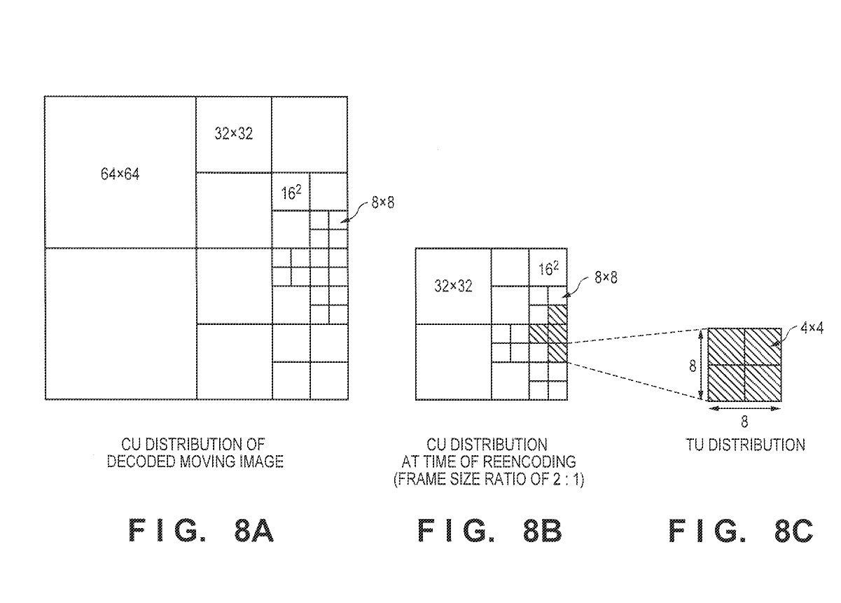

An example of applying the above operation procedure will be described subsequently with reference to FIGS. 8A to 8C. FIG. 8A shows the CU size distribution of a decoded moving image. FIG. 8B shows a CU size distribution if a decoded moving image is re-encoded upon being resized at a frame size ratio of 2:1. FIG. 8C shows a TU size in the re-encoded moving image. In the second exemplary embodiment, CU sizes at the time of re-encoding are also determined in accordance with a frame size ratio as in the first exemplary embodiment. On that basis, if a CU size in a decoded moving image is the minimum size of 8×8 pixels which can be selected in terms of specifications, an orthogonal transformation process is performed for the corresponding CU in the encoded moving image while a pixel size of 4×4 pixels is set as a TU size.

An image block region using a CU size of 8×8 pixels in the decoded moving image in FIG. 8A can be determined to basically have a complex structure as a pictorial pattern. Therefore, at the time of re-encoding in FIG. 8B, it is effective to make setting to divide a CU size of 8×8 pixels indicated by the hatching into TU sizes in addition to selecting a pixel size of 8×8 pixels as a CU size for an image region at the time of re-encoding. This can suppress a deterioration in the image quality of a pictorial pattern having a fine structure by setting a TU size so as to perform orthogonal transformation on a 4×b pixel basis in a region with a CU size of 8×8 pixels which corresponds to the hatched portion, as shown in FIG. 8C.

### Third Exemplary Embodiments

At least one of the various functions, processes, and methods described in the first and second exemplary embodiments can be achieved using a program. Hereinafter, in a third exemplary embodiment, a program for realizing at least one of the various functions, processes, and methods described in the first and second exemplary embodiments will be referred to as a “program X”. Further, in the third exemplary embodiment, a computer for executing the program X will be referred to as a “computer Y”. Examples of the computer Y include a personal computer, a microcomputer, and a central processing unit (CPU).

At least one of the various functions, processes, and methods described in the first and second exemplary embodiments can be realized by the computer Y executing the program X. In this case, the program X is supplied to the computer Y via a computer readable storage medium. A computer readable storage medium according to the third exemplary embodiment includes at least one of a hard disk device, a magnetic storage device, an optical storage device, a magneto-optical storage device, a memory card, a read only memory (ROM), and a random access memory (RAM). Further, the computer readable storage medium according to the third exemplary embodiment is a non-transitory storage medium.

While the present invention is described with reference to exemplary embodiments, it is to be understood that the present invention is not limited to the exemplary embodiments. The scope of the following claims is to be accorded the broadest interpretation so as to encompass all modifications and equivalent structures.

This application claims the benefit of Japanese Patent Application No. 2013-212356, filed Oct. 9, 2013, which is hereby incorporated by reference herein in its entirety.

What is claimed is:

1. An image processing apparatus comprising:
a conversion unit configured to convert a frame size of a decoded moving image;
a determination unit configured to determine a block size for re-encoding the decoded moving image with the frame size being converted; and
an encoding unit configured to encode the decoded moving image with the frame size being converted in accordance with the determined block size.

2. The apparatus according to claim 1, wherein the determination unit divides the decoded moving image with the frame size being converted into first image regions each having a first size.

3. The apparatus according to claim 2, wherein the determination unit divides the first image region into second image regions each having a second size smaller than the first size if the first reference region includes the block size smaller than the first size.

4. The apparatus according to claim 3, wherein the determination unit determines a block size for the re-encoding of the second size if the second size is a minimum block size which the block size can take.

5. The apparatus according to claim 4, wherein the encoding unit includes an orthogonal transformation unit configured to perform orthogonal transformation of the decoded moving image, and
the determination unit divides the second image region into a third size smaller than the second size if all the block sizes included in the second reference region are the second size, and determines a block size for the orthogonal transformation of the third size.

6. The apparatus according to claim 5, wherein the third size for the orthogonal transformation is a pixel size of 4×4 pixels defined by an HEVC standard.

7. The apparatus according to claim 1, wherein block sizes for the re-encoding include image sizes of 64×64 pixels, 32×32 pixels, 16×16 pixels, and 8×8 pixels as encoding units defined by an HEVC standard.

8. A method comprising:
converting a frame size of a decoded moving image;
determining a block size for re-encoding the decoded moving image with the frame size being converted; and
encoding the decoded moving image with the frame size being converted in accordance with the determined block size.

9. A non-transitory storage medium that stores a program for causing a computer to execute a method, the method comprising:
converting a frame size of a decoded moving image;
determining a block size for re-encoding the decoded moving image with the frame size being converted; and
encoding the decoded moving image with the frame size being converted in accordance with the determined block size.

10. An encoding apparatus comprising:
a conversion unit configured to convert a frame size of a decoded moving image;
a determination unit configured to determine a block size for re-encoding the decoded moving image with the frame size being converted; and
an encoding unit configured to encode the decoded moving image with the frame size being converted in accordance with the determined block size.
